(19) United States
(12) Patent Application Publication
(10) Pub. No.: US 2004/0193325 A1
(43) Pub. Date: Sep. 30, 2004

(54) Method and apparatus to prevent medication error in a networked infusion system

(76) Inventors: David Bonderud, Lake Barrington, IL (US); Tuan Bui, Green Oaks, IL (US)

Correspondence Address: Francis C.M. Kowalik, Esq., BAXTER INTERNATIONAL INC., Corporate Counsel, Law Department, One Baxter Parkway, DF3-2E, Deerfield, IL, 60015, US

(21) Appl. No.: 10/396,638

(22) Filed: Mar. 25, 2003

(51) Int. Cl. G05D 7/00

(52) U.S. Cl. 700/282; 128/923

(57) ABSTRACT

Systems and methods are provided for preventing delivery of a nontherapeutic dose of medication to a patient and/or preventing medications from being administered to the patient that causes documented allergic or drug sensitivity reactions to the patient. The networked medication delivery system [20] includes an infusion device [22] programmable by the user with instructions for administering the medication, and a computing device [26] for determining whether the programmed data would yield a clinically acceptable dose or the medication is in the list of documented medication that would cause an allergic or drug sensitivity reaction to the patient. The system may also include at least one monitor [24] for displaying at least a portion of the programmed data, and an alerting device [28] for notifying medical personnel when the inputted dosage data are determined to yield a clinically unacceptable dose or the medication is in the list of documented medications that would cause an allergic or drug sensitivity to the patient. The infusion device may be configured to become deactivated to prevent delivery of the medication, when the dose is outside the therapeutic range or to prevent mediation of documented allergic or drug sensitivity to a patient is delivered to the patient. Also included is a database [27] that may be remotely situated from the system [20] and accessed via a network [30].

### TECHNICAL FIELD

The present invention is directed to a method and apparatus for automatically preventing the administration of non-therapeutic doses of medication and medications known to cause allergic or drug sensitivity reactions to a patient. More particularly, the invention is directed to a method and apparatus that determines if a medication to be administered is outside a range of therapeutic values or of allergic/sensitivity to the patient and alerts the appropriate medical personnel and/or prevents the administration of the medication.

### BACKGROUND ART

According to a 1999 Institute of Medicine Report, “medical errors” attributable to human error contribute to approximately 70,000-100,000 deaths per year. As a designation, medical errors are associated with a multitude of circumstances and causes. Studies, however, show that a significant percentage of serious errors are associated with the administration of intravenous medication.

When drugs are delivered intravenously, they elicit a near-immediate to immediate response in the patient. Thus, if an error is made, there is little time to compensate. Most critical drugs are delivered intravenously. The process of administering a drug integrates a host of variables, ranging from the involvement of several individuals in the delivery process to pharmacological variables such as accurate dosage, correct drug, delivery at a prescribed time, and use of a particular route of administration. Therefore, it is not difficult to comprehend the potential for error, as well as the undesirable probability that the occurrence of an error can result in one or more detrimental effects to the patient.

An intravenous error may be induced at any point throughout the process of ordering, transcribing, dispensing, and administering a drug. For example, an ordering error may occur because an order is illegible, incomplete, or entered on the wrong patient's chart. The use of a misplaced or inappropriate decimal point or unacceptable prescription abbreviation may also lead to an ordering error. An ordering error may also occur because the inappropriate drug is selected or a patient's allergies are not properly identified.

Transcribing errors may occur because an order was not transcribed, not completely signed off, or incorrectly transcribed onto the Medication Administration Record (MAR). Also, on occasion, a patient's allergies are not transcribed or the transcription is illegible.

Dispensing errors may occur as a result of the wrong dose or the misidentification of the medication or the patient. An error in administering a drug may occur at any time during the course of a patient's care and may concern the patient or the identification of the drug, or the time, dose, or route of drug administration.

Notably, research indicates that 60-80% of intravenous errors are attributed to humans. It follows then that one way to reduce the potential for error is to automate as much as possible the various phases of the drug delivery process, including drug ordering, transcribing, dispensing, and administering. Information technology may be utilized for automating portions of this process.

In U.S. Pat. No. 5,781,442 issued to Engleson et al., a fully integrated care management system is disclosed that automates portions of the drug-administration process. The system is connected by a local area network to several computers which include a pharmacy computer, a nursing station computer, and bedside computers. These computers may be connected to clinical devices such as infusion pumps. Memory in the computers store information relating to a patient's care. The pharmacy computer will compare information communicated from the bedside computer to information stored in the pharmacy computer. If the comparison satisfies a predetermined condition, the pharmacy computer downloads pump-operating parameters to the bedside computer. The bedside computer, in turn, programs the infusion pump to operate in accordance with the downloaded operating parameters, obviating the need for the nurse or technician to manually enter the parameters for configuring the pump. Where the pump cannot be automatically configured by downloading parameters from the network, the system only verifies that the right treatment is being administered to the right patient. The pump must then be manually configured by medical personnel.

Although the system of Engleson et al. may be configured to include certain alarms, the system does not check whether the dose to be administered falls within an acceptable therapeutic range for the particular drug. Additionally, by requiring manual programming after confirming that the proposed treatment is correct for the named patient, the system introduces the possibility that the wrong dosage and/or rate of delivery may be programmed into the pump without any means for detecting the error.

Another system, disclosed in U.S. Pat. No. 5,317,506 issued to Coutr\dot{e} et al. and entitled “Infusion Fluid Management System,” automatically checks whether all necessary data have been entered for intravenous medications and prompts the user as to discrepancies. This patent is directed to an infusion pumping system and a pharmacy management system, each located remotely from each other, which in combination manage and analyze prescribed infusion programs. The combined system manages the infusion of one or more drug formulations to a patient, from the make up of the infusion in the pharmacy to the generation of a report for hospital records after the infusion is completed.

In the pharmacy management system of Coutr\dot{e}, patient data and prescription infusate data are entered. The system produces labels having a bar code encoded with infusion delivery instructions and human-readable instructions for placement on the infusate-containing bag and on the patient's chart. The infusion pumping system prompts the user to enter data contained on the infusate label, which may be entered manually via a keypad or via scanning with a bar code reader attached to the pump. The patient's identification data are then read via a bar code reader from the patient's chart or a bracelet. A processor in the pump verifies that the patient'information matches the information on the IV container. The system then checks whether all the data have been correctly entered into the infusion pumping system, including the dosage, by comparing the entered data against the data predetermined for the patient. The system allows the user to change the medication or the drug regimen by manual entry via the keypad.

By comparing the pump-entered data against “predetermined data,” the system of Coutr\dot{e} fails to check whether the pump-entered dosage falls within an acceptable pharmacological range for the prescribed medication. Therefore, the system allows the possibility that an incorrect dosage initially programmed into the pharmacy computer—because the order was illegible or incomplete or included unconventional abbreviations—would go undetected. Nor would such comparison detect transcription errors. Further, the system can be labor-intensive to operate, as it requires each pump to be programmed (or reprogrammed) to compare patient data to medication data. Additionally, the system can be encumbering as it requires the pump to read both the patient code (from the patient's chart or bracelet) and the IV container code. Thus, the physical location of both sets of encoded information in relation to the pump is an important, if not potentially limiting, consideration. Further, the system may prove impractical where pumps are mobilized frequently, requiring disconnection from power and wired data communication but also needing to be programmed with prescription data. In addition, data on patient allergies and changes made to data formats, such as from a one-dimensional bar code to a two-dimensional bar code, must also be reprogrammed separately into each pump, along with any other data that are or may be desirable for administering patient therapy.

U.S. Pat. No. 5,758,095, issued to Albaum et al., attempts to address errors related to ordering and prescribing a therapeutically out-of-range dose of medication. The interactive medication ordering system includes means for alerting the user of potentially adverse situations that can occur as a result of a prescribed medication, based on information in a database concerning, e.g., the maximum allowable dosage of the medication. The system, however, focuses exclusively on the ordering and prescribing aspects of drug delivery and does not include devices or methods for administering the prescribed medication.

Accordingly, a need remains for a system that is easily configurable, reconfigurable, and mobile in application, and that provides a check on the programmed pump data prior to administration of the medication to ensure that the programmed dosage is pharmacologically suitable for the medication. The present invention is provided to solve these and other problems.

### Summary of the Invention

The present invention is directed to systems and methods for ensuring that medication is administered in a safe and therapeutic range to a patient in a hospital or health care facility by providing an automatic check, at a central location in the facility, on the data programmed into a delivery device. Such data may include delivery rate and/or total volume to be infused. The present invention is further directed to systems and methods that provide a check for a patient'documented allergic or drug sensitivity reaction.

In one aspect, the present invention provides a medication delivery system that prevents the delivery of a nontherapeutic dose of medication to a patient by comparing dosage data entered into a delivery device against clinical data for the prescribed medication. When the system determines that the dosage data would yield a clinically unacceptable dose, the system alerts the user of that. The system may also inactivate the delivery device to prevent delivery of the medication.

In another aspect, the present invention provides a medication delivery system that prevents medication having documented allergic reactions or drug sensitivity reactions to a patient from being administered to that patient. The system and method compares the documented allergic reaction or drug sensitivity of the patient against clinical data for the prescribed medication. When the system determines that the medication would yield an allergic or drug sensitivity reaction, the system alerts the user. The system may also inactivate the delivery device to prevent the delivery of the medication.

The system includes a delivery device programmable by a user with dosage data, including instructions, for administering a medication to a patient and a computing device in communication with the delivery device. The computing device determines whether the dosage data programmed into the delivery device would yield a clinically acceptable dose and whether the medication would yield an allergic or drug sensitive reaction by the patient.

In one embodiment, the delivery device is an infusion device, such as an infusion pump, for administering the medication intravenously. The computing device has access to a database of clinical information for determining whether the dosage data would yield a clinically acceptable dose and whether the medication would yield an allergic or drug sensitive reaction by the patient.

The medication delivery system may further comprise an alerting device capable of generating at least one signal to the medical personnel, indicating a clinically unacceptable dose and/or allergic or drug sensitive reaction. The signal so generated may be an audible sound, a visual indication, a text message, and a paging signal.

The dosage data programmed into the infusion device include the name of the medication and at least one of total dosage, delivery rate, delivery volume, type of diluent, amount of diluent, dose time, duration of delivery, and route of administration. The system may also include at least one monitor for displaying at least a portion of the programmed data.

The dosage and medication data are generally entered into the infusion device manually by a keypad affixed to the infusion device or otherwise in communication with the infusion device. In an alternative embodiment, the dosage and medication data may be entered by scanning the drug delivery instructions and data via, e.g., a bar code reader or other conventional means.

In another aspect of the invention, a networked medication delivery system is presented. In this aspect, the medication delivery system includes an infusion device programmable by a user with drug-delivery instructions for administering a dose of medication to a patient. The system also includes means for comparing the dose to clinical dosage data for the medication contained in a database to determine whether the dose is pharmacologically acceptable. The system further includes means for comparing the documented allergic reaction or drug sensitivity of the patient against clinical data for the prescribed medication. Also included in the system is an alerting device for notifying medical personnel, prior to administration of the medication to the patient, when the medication and dose is not pharmacologically acceptable. A network integrates all three components—i.e., the infusion device, the means for comparing, and the alerting device.

The drug-delivery instructions programmed into the infusion device include, but are not limited to, the name of the medication and at least one of total dosage of the medication, delivery rate, delivery volume, type of diluent, amount of diluent, dose time, duration of delivery, and route of administration. The clinical data are accessible from a database having data for the prescribed medication, along with other medications. In one embodiment, the database may also be incorporated into the network. In an alternative embodiment, the database may be external to the health care facility or hospital that houses the infusion device. In such embodiment, the database is accessible by, e.g., an intranet or the Internet. In yet another embodiment, the database may be part of the means for comparing; e.g., where the database is contained within a central server.

Yet another aspect of the invention is a method of preventing the delivery of a medication at a dose outside a therapeutic range for the prescribed medication. The method includes programming an infusion device with dosage data for delivering a medication to a patient; determining whether the dosage data will yield a dose within a therapeutic range for the medication; and alerting medical personnel when the dose is outside the therapeutic range, before any medication is administered to the patient. The determining step may comprise comparing the dosage data against clinical data for the medication. The method may further include automatically inactivating the infusion device to prevent delivery of the medication.

The comparing step may include accessing a database of clinical data for the prescribed medication and others, where the data specify what dose levels are pharmacologically acceptable for the medication. Such a database may be located within the health care facility or, alternatively, outside the facility but accessible via a network. In one embodiment, in the programming step, the infusion device is networked with a processor, an alerting device, and at least one monitor.

In the programming step, the medication data may include the name of the medication and the dosage data may include at least one of total dosage, delivery rate, delivery volume, type of diluent, amount of diluent, dose time, duration of delivery, and route of administration. The programming step may include entering the medication or dosage data into the infusion device via a keypad in communication with the infusion device.

Other aspects of the invention will become apparent when taken in conjunction with the following description and drawings.

### BRIEF DESCRIPTION OF DRAWINGS

FIG. 1 is a block diagram showing the components of a networked infusion system for preventing medication error in accordance with the present invention;

FIG. 2 shows one example of the type of dosage delivery data displayed on a screen of a monitor of FIG. 1 in accordance with the invention;

FIG. 3 is a schematic of a pump from the networked infusion system of FIG. 1, set up to accommodate more than one container of medication to be dispensed; and

FIG. 4 is a flow chart of the overall operation employed by the networked infusion system shown in FIG. 1.

### DETAILED DESCRIPTION

While the invention is susceptible of embodiments in many different forms, there is shown in the drawings and will herein be described in detail preferred embodiments of the invention. It is to be understood that the present disclosure is to be considered as an exemplification of the principles of the invention. This disclosure is not intended to limit the broad aspects of the invention to the illustrated embodiments.

The present invention provides a system, suitable for use in hospitals or other health care facilities (hereinafter collectively referred to as “facilities”), that reduces the risk of medication delivery errors. More importantly, the invention provides a system for preventing the intravenous (IV), epidural, intrathatecal, and subcutaneous administration of medication when the dose programmed to be administered falls outside the range of pharmacologically acceptable levels for the prescribed medication. In the event that a clinically unacceptable dose is programmed for delivery, the system immediately alerts medical personnel so the error may be corrected. The invention further provides a system for preventing administration of medication when it is determined that the patient is allergic or sensitive to that medication. In the event that the patient is allergic or sensitive to the medication programmed for delivery, the system alerts medical personnel.

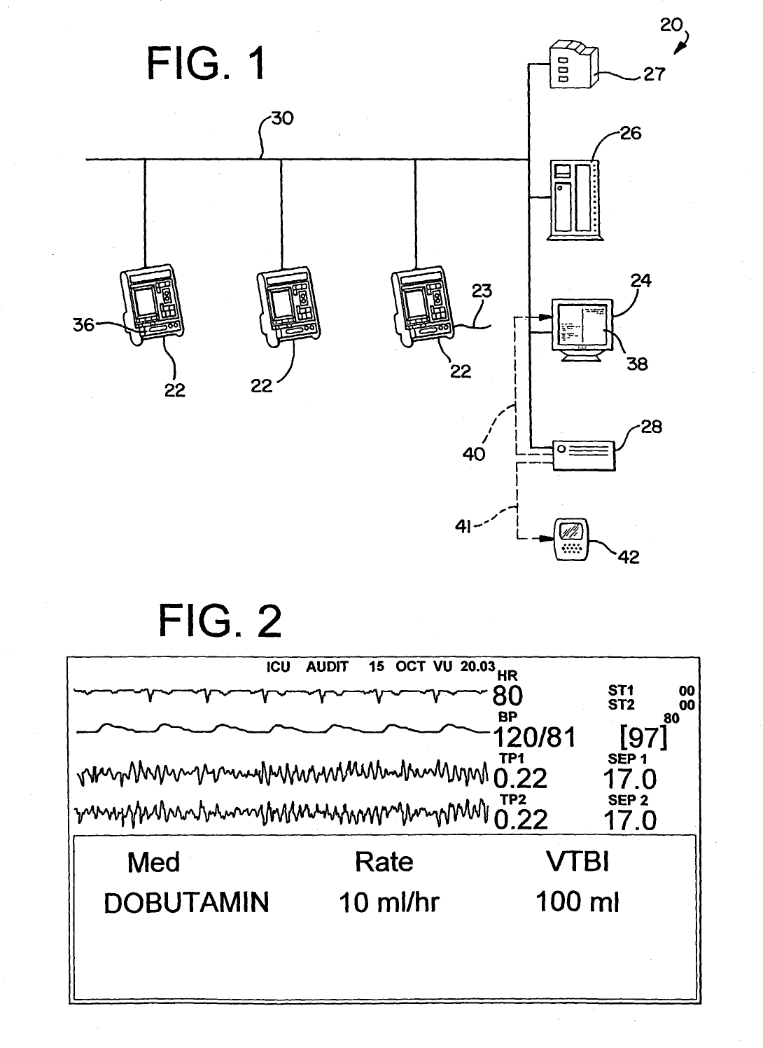

Referring to the drawings and specifically to the block diagram of FIG. 1, a networked medication delivery system 20 embodying the present invention is generally disclosed. The system 20 includes an infusion device 22 that is programmable by a user with medication data, dosage data and instructions for administering the medication to a patient. The system 20 also includes at least one monitor 24 for displaying at least a portion of the data programmed into the infusion device 22. Also included is a computing device 26, also called a “processor,” for determining whether the medication and the dose of the medication programmed for administration is clinically acceptable. Additionally, the system 20 includes an alerting device 28 for notifying medical personnel when the medication or the dose is not clinically acceptable. Because the system 20 may be used to check the dose programmed into a number of infusion devices, the system 20 typically includes more than one infusion device 22, as shown in FIG. 1.

The infusion device 22 and the computing device 26 are interconnected via a network 30, which is typically a local area network (LAN), as shown in FIG. 1. For illustration purposes, the network is shown as a wired network in which the medication delivery system is connected via cable. The network can also be a wireless network where the medication delivery system is connected via wireless network and the infusion device and computing device are integrated via the wireless network. Preferably, the monitor 24 is included in the network, along with the alerting device 28. In one embodiment, the alerting device 28 is incorporated into the monitor 24 for providing visual notification of a medication error. Also included in the medication delivery system 20 is a database 27. Database 27 contains the clinical data used as a reference for determining whether the dose programmed into the infusion device 22 is within a therapeutic range for the medication. The database 27 further contains patient information regarding the patient's sensitivity and allergies to particular medications.

The infusion device 22 is typically an infusion pump such as a peristaltic pump and is generally located at the patient's bedside. The infusion device 22 generally has suitable means for programming; e.g., a keypad 36 for manual input of data and commands by a nurse or other medical personnel. The keypad 36 is typically affixed to the infusion device 22 or otherwise in communication with the infusion device 22 for programming the infusion device 22 with the medication and dosage data. Via the keypad 36, the user may program the infusion device 22 by entering data that identifies the patient and the medication to be administered and defines the instructions for administration, as prescribed. As the infusion device 22 is preferably capable of administering the medication intravenously, the dose of medication programmed for delivery is typically provided to the patient via, e.g., a catheter 23. It is further contemplated that administration of the medication can also be made epidurally, intrathetically, and subcutaneously.

The monitor 24 can be positioned at various locations in the facility, such as at the nurses' station, for example. Typically, the monitor 24 is located remotely from the infusion device 22; however, in one embodiment, the monitor 24 may be situated at the patient'bedside. The monitor 24 has a screen 38 for displaying certain selected data inputted into the infusion device 22 and sent to the monitor 24 for display. The monitor 24 is capable of displaying the medication name, dosage, rate of delivery, total volume to be infused, and time for delivery. Other relevant information such as the name of the patient and the patient's room number may also be displayed.

FIG. 2 shows one example of the type of information that can be displayed on the screen 38 of the monitor 24. Specifically, in FIG. 2, the screen 38 displays the name of the medication (Dobutamine), the rate of delivery (10 milliliters per hour), and the volume to be infused (100 milliliters).

The processor 26 may be a server computer, a personal computer, or a Palm unit, as examples. In one embodiment, the processor 26 may be a central server associated with, containing, or otherwise having access to the database 27. Upon receipt of the inputted data, the processor 26 accesses the database 27 and conducts a comparative analysis of the inputted medication and dosage information against clinical data in the database 27 for the prescribed medication to determine whether the dosage programmed into the infusion device 22 falls within a pharmacologically acceptable—i.e., therapeutic—range for the prescribed medication and whether the patient is sensitive or allergic to the prescribed medication. For example, the processor 26 checks to ensure that the programmed parameters, such as infusion rate and volume to be infused, will yield a dose within the therapeutic range defined for the medication. Such comparison may be made using dosage-related information stored in a single database or several different databases.

In one embodiment, the processor may use additional information in its analysis of the dosage data. For example, the processor may consider the patient's weight, allergies, other prescriptions for medications, medical history, diet, and other details as appropriate.

Clinical data in the database 27 may include, e.g., data on the medication, the range of pharmacologically acceptable dosages, the maximum allowable dosage for a defined time period, the lowest therapeutic dosage below which the drug is not effective, routes of delivery, and other pertinent data. Database 27 may be part of the processor 26, such as a part of the central server. Alternatively, the database 27 may be incorporated into the network 30 as a separate component. For example, the database 27 may be at a location remote from the computing device or processor 26—such as outside the hospital or health care facility housing the infusion device—but accessible via an intranet or the Internet.

Shown in FIG. 1, the alerting device 28 is connected to other components of the system 20 by the network 30. In an alternative embodiment, the alerting device 28 may be incorporated into the monitor 24 for notifying medical personnel of a medication error. Upon determining that the programmed parameters would yield a dosage outside the therapeutic range and/or a medication that the patient is allergic or sensitive to, the processor 26 activates the alerting device 28. System 20 detects the out-of-range value and causes the alerting device 28 to generate at least one signal 40 to alert medical personnel of the error before any medication is allowed to be administered. The signal 40 so generated generally comprises at least one of an audible sound, a visual indication, a text message, and a paging signal. For example, the monitor screen 38 may display an inputted value in red, flashing on and off; or some portion of the displayed information may appear in a different color or change to another color. Alternatively, the signal 40 may be textual in nature; e.g., a text message displayed on the monitor 24, such as “Alert: Rate Outside Therapeutic Range” or “Alert: Patient Is Sensitive to Medication.” Another alternative format is a paging signal 41 for transmission to a medical attendant (e.g., to a pager 42) or to the nurses' station for alerting an attendant to correct the dosage and/or medication.

In another embodiment, the medication delivery system 20 utilizes a combination of at least two types of signals to ensure that medical personnel are alerted to the problem. Whether implemented singly or in any combination, each of these measures helps prevent a patient sensitive medication or nontherapeutic dose of medication from being administered as a result of misprogramming the infusion device 22.

The patient identification data programmed into the infusion device 22 may include, but are not limited to, the patient's name, age, room number, and physician's name, as examples. The medication data may include, but are not limited to, the medication order number and drug name. The delivery instructions programmed into the infusion device 22 may include, but are not limited to, the name of the medication and at least one of total dosage, delivery rate, delivery volume, type of diluent, amount of diluent, dose time, duration of delivery, and route of administration. Preferably, the delivery instructions include at least one of total dosage, delivery rate, and time at which delivery is to begin and end. For intravenous administration, the delivery instructions may further include primary rate, primary volume to be infused (VTBI), piggyback VTBI, piggyback rate or time, primary dose mode, and pump channel identification.

In another embodiment, the infusion device 22 incorporates alternative means for programming pertinent information. For example, instructions for dispensing the medication may appear on the medication or on the packaging or other material that accompanies the medication. The programming instructions may be in a machine-readable format such as linear bar codes, two-dimensional bar codes, printed data encoding technology, radio frequency identification technology, magnetic strips, magnetic tapes, optical character recognition technology, and optical holograms. Data in these alternative forms may be programmed into the infusion device by a variety of means, including, e.g., a built-in bar code scanner, a touch screen in communication with the device, a radio frequency identification reader, a wireless receiver, a magnetic strip reader, a magnetic tape reader, an optical reader, or by an external wireless transmitter or transceiver. These various programming means may be in communication with the infusion device 22.

Notably, the medication delivery system 20 can be configured to deliver medication in several different arrangements including parenteral and intravenous delivery.

In the present invention, the prescribed medication is typically a fluid, which includes both liquids and gases. A preferred liquid formulation is an intravenous parenteral formulation. Examples of other parenteral liquid formulations suitable in the present invention are intrathecal, epidural, intra-arterial and the like. Examples of gas-based medications include the inhaled anesthetic gases such as sevoflurane, halothane, and enflurane. More than one medication may be delivered at the same time by system 20.

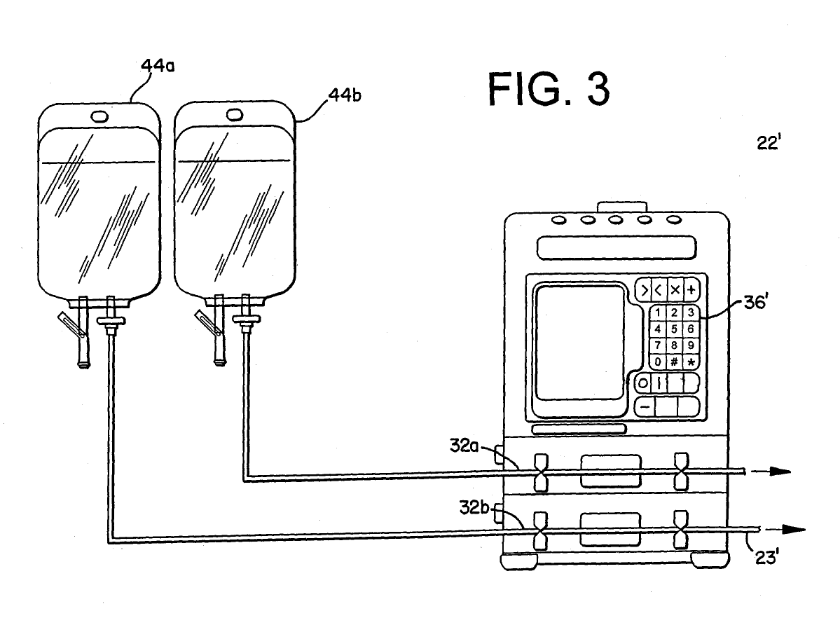

If more than one medication is to be delivered, the medications may be held in the same container or separate containers. In intravenous infusions, it is common that additional medications may be delivered as a piggyback. FIG. 3 shows one embodiment of the infusion device 22′ set up to accommodate multiple containers 44a and 44b, each container being connected to a separate pump channel 32a and 32b, respectively, on the infusion device 22′. Each pump channel 32a and 32b can be uniquely programmed via the key pad 36′.

The system 20 may also prevent the delivery of patient sensitive medications and clinically unacceptable doses of medication. After determining whether the medication and dose programmed into the infusion device 22 is clinically acceptable, the processor 26 is configured to send a signal to the infusion device 22 and the infusion device 22 is configured to receive and act upon that signal. In one embodiment, the infusion device 22 receives an activating signal before it starts delivering the medication. In such embodiment, when the medication and dose is found to be clinically acceptable, the processor 26 sends to the infusion device 22 a signal that activates the infusion device 26 to commence delivery of the medication. In an alternative embodiment, the infusion device is configured to deliver the medication at the programmed dose unless it is inactivated. In such embodiment, the processor 26 sends to the infusion device 22 a signal that inactivates the infusion device 26 so as to prevent any medication from being delivered. The system then requires user intervention—i.e., reprogramming the pump—to re-start the drug delivery process, including the checking of the reprogrammed data.

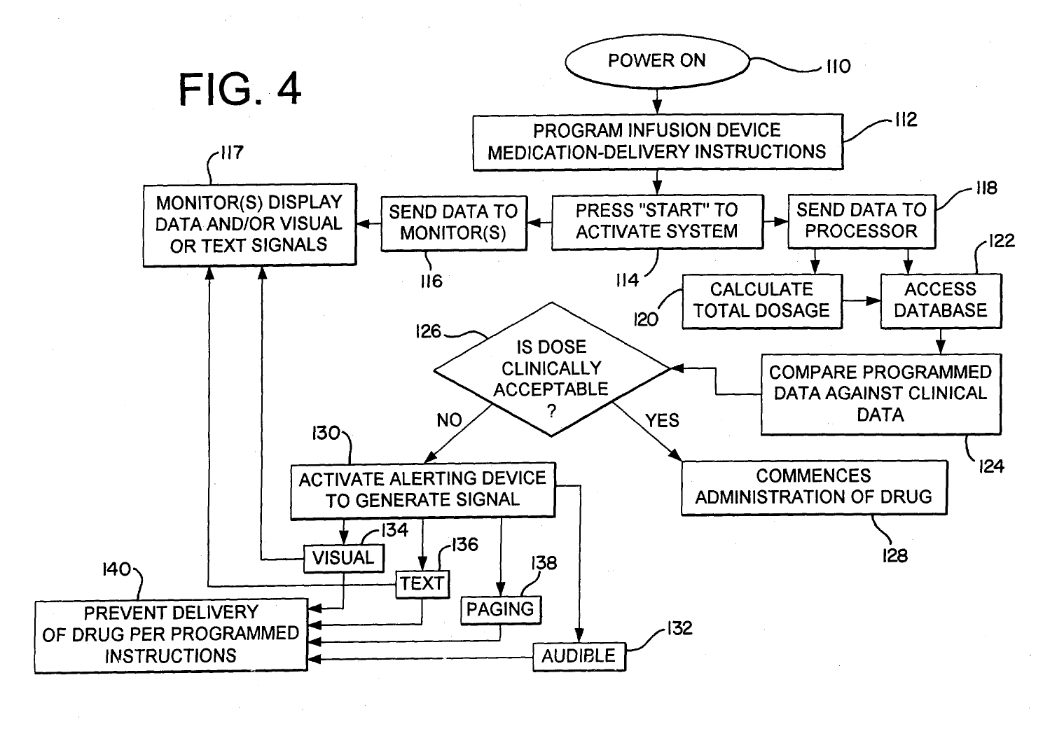

In another aspect of the invention, a method is provided for preventing the delivery of medication at a dose outside the range of therapeutic values. FIG. 4 shows a flow chart of the method of the present invention. The equipment, hardware, and database that can be utilized in the method are substantially as described above.

The method begins with turning on the power to the medication delivery system 20 (shown by reference number 110). The container of the prescribed medication is engaged with the infusion device 22, described above, for delivery to the patient. The user then programs the infusion device 22 (reference number 112), with information such as the patient's name, room number, as examples, and dosage and medication-delivery instructions as described above. The programming step includes entering the dosage data manually into the infusion device 22 via, e.g., the keypad 36 or other suitable means, such as a touch screen in communication with the delivery device. The dosage data programmed into the infusion device 22 generally include the name of the medication and at least one of total dosage, delivery rate, delivery volume, type of diluent, amount of diluent, dose time, duration of delivery, and route of administration. Preferably, the entered data include at least one of total dosage, total volume, rate of delivery, and time for commencing delivery. If more than one medication is to be delivered in a piggyback fashion, the user inputs dosage and delivery instructions into the infusion device 22 for these medications as well.

The information concerning the prescribed medication that is to be programmed into the infusion device 22 is generally provided on the medication container or any other suitable means. Preferably, the drug delivery instructions are generated by a pharmacist who prepares the medication and attaches a label to the medication container with instructions for administration. Alternatively, the instructions for delivery can be generated by a drug manufacturer and affixed to the medication container. In yet another embodiment, the drug information may be accessible via conventional means, including the patient's chart or a patient care management system.

The user activates the medication infusion system 20 typically by interacting with the system; e.g., by pressing a “start” button (reference number 114).

As shown by reference number 116, if desired, the system 20 can send the inputted data to at least one monitor 24 situated in various locations of the facility; e.g., at the nurses' station, the patient's bedside, and/or outside the patient's room. As shown by reference number 117, the monitor 24 displays at least a portion of the data entered into the infusion device 22 concerning the medication-delivery process, such as the medication name, dosage, rate of delivery, total volume to be infused, and time for delivery, as examples, along with other relevant information such as the patient's name and his room number. Preferably, the displayed data include at least one of the medication name, rate of delivery, and total volume to be infused.

Either prior to or contemporaneously with sending the data to the monitor(s) 24, the system 20 also sends data to the processor 26 about the nature and dosage of the medication to be delivered from the infusion device 22 (reference number 118). Depending upon the type of data entered into the infusion device 22—e.g., where the entered data may include rate of delivery and duration of delivery—the method may include calculating the total dose of the medication to be administered to the patient (reference number 120). The processor 26 accesses the database 27 of clinical data, located either within the facility or outside the facility but accessible via a network (as shown by reference number 122). The processor 26 compares the medication to drug sensitivity data in the database and performs a comparative analysis of the clinical ranges for the prescribed medication against the dose programmed into the infusion device 22 (reference number 124) and determines whether the dose programmed into the infusion device 22 is clinically acceptable (reference number 126). If the medication and programmed dosage falls within the clinically acceptable range set forth in the database, the processor 26 may be configured to send a signal to activate the infusion device 22 to commence administration of the medication to the patient (as shown by reference number 128).

If the programmed delivery instructions would result in a clinically unacceptable dose of the drug, the processor 26 makes such determination and activates an alerting device 28 to elicit at least one signal 40. Indicating a clinically unacceptable dose, the signal 40 notifies medical personnel of the medication error. This is shown by reference number 130 in FIG. 4. The signal 40 may take a variety of forms, including an audible sound (shown by reference number 132) and a visual indication (shown by reference number 134) such as lights flashing or the use of a different colored light—e.g., red on the monitor screen 38 to indicate a problem. The signal 40 may also include a text message (136) displayed on the screen 38 or other suitable display; or a paging signal (138) for transmission to medical personnel via a pager 42 or to the nurses' station. The visual notification and/or text message may be displayed on monitor screen 38 (reference number 117).

At about the same time, in one embodiment, the processor may generate a signal to inactivate the infusion device 22 so it does not administer the medication (as shown by reference number 140) pursuant to the programmed drug-delivery instructions. The system then requires user intervention—i.e., reprogramming the pump—to re-start the drug delivery process, including the checking of the reprogrammed data.

In a preferred embodiment, after the processor 26 analyzes the type of medication and inputted dosage data with respect to patient drug sensitivity data and clinical values, if the dose to be administered is clinically acceptable, the processor 26 sends a signal to the infusion device 22, activating it to commence administration of the medication. This step is shown in FIG. 4 by reference number 128. In another embodiment, the system may be configured so the infusion device 22 starts to deliver the drug according to the rate and dosage programmed into the infusion device 22, and inactivates delivery upon receipt of the signal 40 from the processor 26. In yet another embodiment, the system 20 may be configured so the infusion device 22 starts administering the drug to the patient after a predetermined time delay, to allow the processor 26 to confirm that the programmed dose is clinically acceptable.

While specific embodiments have been illustrated and described, numerous modifications are possible without departing from the spirit of the invention, and the scope of protection is only limited by the scope of the accompanying claims.

What is claimed is:

1. A medication delivery system for preventing delivery of a nontherapeutic dose of medication to a patient, the system comprising:
a delivery device programmable by a user with dosage data for administering a medication to a patient; and
a computing device in communication with the delivery device for determining whether the dosage data programmed into the delivery device would yield a clinically acceptable dose.

2. The medication delivery system of claim 1 further comprising an alerting device capable of generating at least one signal indicating a clinically unacceptable dose.

3. The medication delivery system of claim 1 wherein the system further prevents delivery of medications causing an allergic reaction to the patient wherein the delivery device is programmable with drug medication data and the computing device determines whether the patient is allergic to the medication programmed into the delivery device.

4. The medication delivery system of claim 1 wherein the system further prevents delivery of medications causing drug sensitivity reaction to the patient wherein the delivery device is programmable with drug medication data and the computing device determines whether the patient is sensitive to the medication programmed into the delivery device.

5. The medication delivery system of claim 2 wherein the at least one signal comprises one of an audible sound, a visual indication, a text message, and a paging signal.

6. The medication delivery system of claim 1 wherein the delivery device is capable of administering the medication intravenously.

7. The medication delivery system of claim 1 wherein the delivery device is capable of administering the medication epidurally.

8. The medication delivery system of claim 1 wherein the delivery device is capable of administering the device intrathecally.

9. The medication delivery system of claim 1 wherein the delivery device is capable of administering the medication subcutaneously.

10. The medication delivery system of claim 4 wherein the delivery device comprises an infusion pump.

11. The medication delivery system of claim 1 wherein the delivery device is configured to be programmed with dosage data comprising at least one of total dosage, delivery rate, delivery volume, type of diluent, amount of diluent, dose time, duration of delivery, and route of administration.

12. The medication delivery system of claim 1 wherein the delivery device further comprises means for programming the delivery device.

13. The medication delivery system of claim 12 wherein the means for programming comprises a keypad in communication with the delivery device for programming the delivery device with the dosage data.

14. The medication delivery system of claim 12 wherein the means for programming comprises a touch screen in communication with the delivery device for programming the delivery device with dosage data.

15. The medication delivery system of claim 12 wherein the means for programming comprises one of a built-in bar code scanner, a radio frequency identification reader, a wireless receiver, a magnetic strip reader, a magnetic tape reader, and an optical reader.

16. The medication delivery system of claim 12 wherein the means for programming comprises a built-in wireless receiver in communication with an external wireless transceiver.

17. The medication delivery system of claim 16 wherein the delivery device is configured to be programmed with the dosage data in a machine-readable format.

18. The medication delivery system of claim 17 wherein the machine-readable format comprises one of linear bar codes, two-dimensional bar codes, printed data encoding technology, radio frequency identification technology, magnetic strips, magnetic tapes, optical character recognition technology, and optical holograms.

19. The medication delivery system of claim 1 wherein the infusion device and the computing device are integrated via a network.

20. The medication delivery system of claim 1 wherein the infusion device and the computing device are integrated via a wireless network.

21. The medication delivery system of claim 1 further comprising at least one monitor in communication with the delivery device and the computing device for displaying at least a portion of the dosage data programmed into the infusion device.

22. The medication delivery system of claim 21 wherein the at least one monitor is located remotely from the infusion device.

23. The medication delivery system of claim 21 wherein the at least one monitor is capable of displaying at least one of medication name, patient allergy, patient drug sensitivity, dosage, rate of delivery, total volume to be infused, and time for delivery of the medication.

24. The medication delivery device of claim 1 wherein the computing device has access to a database of clinically acceptable dosages for determining whether the dosage data would yield a clinically acceptable dose.

25. The medication delivery system of claim 24 wherein the database is at location remote from the computing device.

26. The medication delivery system of claim 1 further comprising means for inactivating the delivery device when the dose is clinically unacceptable.

27. The medication delivery system of claim 1 wherein the computing device is configured to send to the delivery device a signal that the dose is clinically acceptable, and the delivery device is configured to administer the dose upon receipt of the signal from the computing device.

28. The medication delivery system of claim 1 wherein the computing device is configured to send to the delivery device a signal that the dose is clinically unacceptable, and the delivery device is configured to not administer the dose upon receipt of the signal from the computing device.

29. A networked medication delivery system comprising:
an infusion device programmable by a user with drug-delivery instructions for administering a dose of medication to a patient;
means for comparing the dose to clinical dosage data in a database to determine whether the dose is pharmacologically acceptable for the medication;
an alerting device for notifying medical personnel, prior to administration of the medication, when the dose is not pharmacologically acceptable; and
a network integrating the infusion device, the means for comparing, and the alerting device.

30. The medication delivery system of claim 29 wherein the infusion device is capable of administering the medication intravenously.

31. The medication delivery system of claim 29 wherein the delivery device is capable of administering the medication epidurally.

32. The medication delivery system of claim 29 wherein the delivery device is capable of administering the device intrathecally.

33. The medication delivery system of claim 29 wherein the delivery device is capable of administering the medication subcutaneously.

34. The medication delivery system of claim 30 wherein the infusion device comprises a pump.

35. The medication delivery system of claim 29 wherein the infusion device is configured to be programmed with drug-delivery instructions comprising at least one of total dosage of the medication, delivery rate, delivery volume, type of diluent, amount of diluent, dose time, duration of delivery, and route of administration of the medication.

36. The medication delivery system of claim 29 further comprising means for programming the infusion device.

37. The medication delivery system of claim 36 wherein the means for programming comprises a keypad in communication with the infusion device.

38. The medication delivery system of claim 29 wherein the means for programming comprises one of a built-in bar code scanner, a radio frequency identification reader, a wireless receiver, a magnetic strip reader, a magnetic tape reader, and an optical reader.

39. The medication delivery system of claim 36 wherein the means for programming comprises one of a built-in wireless receiver in communication with an external wireless transceiver.

40. The medication delivery system of claim 29 wherein the infusion device is configured to be programmed with the instructions in a machine-readable format.

41. The medication delivery system of claim 40 wherein the machine-readable format comprises one of linear bar codes, two-dimensional bar codes, printed data encoding technology, radio frequency identification technology, magnetic strips, magnetic tapes, optical character recognition technology, and optical holograms.

42. The medication delivery system of claim 29 further comprising at least one monitor integrated into the network for displaying at least a portion of the drug-delivery instructions programmed into the infusion device.

43. The medication delivery system of claim 30 wherein the at least one monitor is capable of displaying at least one of medication name, dosage, rate of delivery, total volume to be infused, and time for delivery of the medication.

44. The medication delivery system of claim 29 wherein the alerting device incorporates at least one monitor for providing visual notification that a dose is not pharmacologically acceptable.

45. The medication delivery system of claim 29 wherein the alerting device is capable of generating a signal comprising at least one of an audible sound, a visual indication, a text message, and a paging signal when the dose is not pharmacologically acceptable.

46. The medication delivery system of claim 29 wherein the database is situated remotely from the means for comparing.

47. The medication delivery system of claim 29 wherein the database containing the clinical dosage data is located outside a facility that houses the infusion device.

48. The medication delivery system of claim 29 wherein the means for comparing is capable of generating a signal to inactivate the infusion device when the dose is not pharmacologically acceptable.

49. The medication delivery system of claim 29 wherein the means for comparing is capable of generating a signal to activate the infusion device when the dose is pharmacologically acceptable.

50. A method of preventing the delivery of a medication at a dose outside a therapeutic range for the medication, the method comprising:
programming an infusion device with dosage data for delivering a medication to a patient;
determining whether the dosage data will yield a dose within a therapeutic range for the medication; and
alerting medical personnel when the dose is outside the therapeutic range, before any medication is administered to the patient.

51. The method of claim 50 wherein in the programming step, the dosage data include at least one of total dosage, delivery rate, delivery volume, type of diluent, amount of diluent, dose time, duration of delivery, and route of administration.

52. The method of claim 50 wherein the programming step includes entering the dosage data into the infusion device via a keypad in communication with the infusion device.

53. The method of claim 50 wherein the determining step includes calculating the dose of the medication to be delivered to the patient.

54. The method of claim 50 wherein the determining step includes accessing a database for the clinical data.

55. The method of claim 50 wherein the alerting step includes generating at least one of an audible sound, a visual indication, a text message, and a paging signal for notifying the medical personnel that the dose is outside the therapeutic range.

56. The method of claim 50 wherein the alerting step includes generating a paging signal for transmission to medical personnel.

57. The method of claim 50 wherein the alerting step includes generating a text message for display on at least one monitor.

58. The method of claim 50 wherein the programming step includes entering dosage data into the infusion device in a machine-readable format.

59. The method of claim 50 wherein the determining step comprises comparing the dosage data against clinical data for the medication.

60. The method of claim 50 further including inactivating the infusion device to prevent delivery of the medication when the dose is outside the therapeutic range for the medication.

61. The method of claim 50 further including activating the infusion device to deliver of the medication when the dose is within the therapeutic range for the medication.

62. A system for preventing delivery of medication to a patient, the system comprising:
a delivery device programmable with drug medication data for administering a medication to a patient and;
a computing device in communication with the delivery device for determining whether the patient is allergic to the medication programmed into the delivery device,
wherein the computing device has access to a database of patient allergy information for determining whether the medication would cause an allergic reaction by the patient wherein the system prevents delivery of the programmed medication if it is determined that the medication may cause an allergic reaction by the patient.

63. A system for preventing delivery of medication to a patient, the system comprising:
a delivery device programmable with drug medication data for administering a medication to a patient and;
a computing device in communication with the delivery device for determining whether the patient is sensitive to the medication programmed into the delivery device,
wherein the computing device has access to a database of patient drug sensitivity information for determining whether the medication would cause a drug sensitive reaction by the patient wherein the system prevents delivery of the programmed medication if it is determined that the medication may cause a drug sensitivity reaction by the patient.
